(19) United States
(12) Patent Application Publication
(10) Pub. No.: US 2004/0253348 A1
(43) Pub. Date: Dec. 16, 2004

(54) Shield for food product

(76) Inventors: Steven J. Woodward, McKinney, TX (US); Todd W. Craig, Plano, TX (US); Steven A. Amigh, Plano, TX (US); Andre Holman, Garland, TX (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/819,058

(22) Filed: Apr. 6, 2004

Related U.S. Application Data
(60) Provisional application No. 60/460,917, filed on Apr. 7, 2003.

(51) Int. Cl. A21D 8/00

(52) U.S. Cl. 426/94

(57) ABSTRACT

A shield for a food product in a baking environment is constructed for manual placement into close association with a pan for supporting the food product. The shield has a shape generally corresponding to the pan and includes a first region defining a plurality of first apertures extending through the shield, a sidewall bordering the first region, and a ledge bordering the sidewall and at least partially defining a plurality of second apertures extending through the shield. The plurality of second apertures extends across the border between the ledge and the sidewall such that a portion of each second aperture is defined in the ledge and another portion of each second aperture is defined in the sidewall. The ledge is constructed for support by a rim of the pan, and the plurality of second apertures is constructed to allow airflow away from the food product outwardly through the shield.

### CROSS-REFERENCE TO RELATED APPLICATIONS

The subject matter of this patent application is related to the subject matter of U.S. Provisional Patent Application No. 60/460,917, filed Apr. 7, 2003, priority to which is claimed under 35 U.S.C. § 119(e) and which is incorporated herein by reference.

### BACKGROUND OF THE INVENTION

Commercial food items, such as pizza, often are baked in a metal pan that is subjected to substantial heating or baking energy. Baking energy often is supplied from above the pizza with impinging jets of gas, such as hot air or superheated steam, or less rigorous means of convection heat, to name several examples of more traditional thermal-energy transfer. In the case of pizza and other generally flat, generally planar food products, such heat transfer usually is considered more effective if the heat is directed toward the product in a direction generally perpendicular to the plane in which the product lies. Heating a pizza or other food product from below also frequently occurs, and often is achieved by thermal conduction through a metal pan base while the pizza is baking.

In the commercial pizza industry, for example in pizza restaurants and pizza delivery environments, it is generally considered desirable to achieve short baking times. This decreases customer wait time and allows more rapid oven and table turnaround. In theory, the speed of heating can be greatly accelerated by simply raising oven temperature. However, if the temperature is too high, the crust of the pizza and the surface topping of the pizza may burn, while the center of the pizza remains cold and insufficiently cooked, or even completely raw. The problem is heightened in that the outer rim of a pizza is particularly prone to burning and drying while generally suffering the most exposure to the sources of heat. Another problem lies in that the heating process can be decelerated by the evaporation of moisture from an uncovered, baking pizza, in much the same way that perspiration cools a human body by evaporating from the skin.

Consistency in product also is desired, from pizza to pizza and from restaurant to restaurant. However, differences in oven type, oven load, placement within the oven, dough type, product size, and number or amount of toppings, for example, can create difficulties in achieving such consistency. Achieving acceptable consistency can be especially difficult without introducing operational complexities that are unacceptable in commercial restaurant environments.

### SUMMARY OF THE INVENTION

A shield for a food product in a baking environment is constructed for manual placement into close association with a pan for supporting the food product. The shield has a shape generally corresponding to the pan and includes a first region defining a plurality of first apertures extending through the shield, a sidewall bordering the first region, and a ledge bordering the sidewall and at least partially defining a plurality of second apertures extending through the shield. The plurality of second apertures extends across the border between the ledge and the sidewall such that a portion of each second aperture is defined in the ledge and another portion of each second aperture is defined in the sidewall. The ledge is constructed for support by a rim of the pan, and the plurality of second apertures is constructed to allow airflow away from the food product outwardly through the shield.

### BRIEF DESCRIPTION OF THE DRAWINGS

Embodiments of the invention are described with respect to the figures, in which like reference numbers denote like elements and in which:

FIG. 1 is a top perspective view of a food-product shield, according to an embodiment of the invention;

FIG. 2 is a top view of a FIG. 1 shield, according to an embodiment of the invention;

FIG. 3 is a perspective view of the underside of a FIG. 1 shield, according to an embodiment of the invention;

FIG. 4 is a side cross-sectional view of a FIG. 1 shield, according to an embodiment of the invention;

FIG. 5 is a top view of a pan for use with a FIG. 1 shield, according to an embodiment of the invention;

FIG. 6 is a side cross-sectional view of the FIG. 5 pan supporting a food product and the FIG. 1 shield, according to an embodiment of the invention; and

FIG. 7 is a side cross-sectional view of a food-product shield, according to an embodiment of the invention.

### DETAILED DESCRIPTION OF PREFERRED EMBODIMENTS

According to embodiments of the invention, a cooking utensil in the form of a pan shield is designed for shielding pizza during the baking process. Shielding systems and methods according to the invention, however, are not limited to use with pizza and pizza-type food products. They have wide application for use in cooking other foods, including pies, cookies, pastries, and numerous other food products. Thus, while preferred embodiments of the invention will at times be described with respect to pizza, pizza-type products and related hardware, the invention is not limited to these embodiments.

With various types of pizza and other products, it is desirable to use a very intense heat environment to thoroughly cook the product in a relatively short amount of time. This has significant application, for example, in the chain pizza-restaurant setting, where it is desirable to minimize customer wait-time while still presenting product that is acceptably prepared and baked. For optimal presentation, many pizzas use somewhat fragile dough that is quite susceptible to heat and therefore more likely to burn, excessively brown or otherwise overbake. Additionally, regardless of the robustness or type of dough, some pizzas undergo variations in quality due to oven type, placement within the oven, number of toppings or other ingredients, and/or differences in oven load (e.g. the number of food products simultaneously present in the oven or other baking environment). It is desirable, therefore, to limit the amount of heat applied to the top of the product, for example impingement heat, while reducing or eliminating product variations that can reduce product quality to an unacceptable level. It is also desirable to reduce evaporation of moisture from the surface of the product, which can decelerate heating and result in unacceptable dryness. Additionally, it is desirable to minimize operational complexity in achieving these advantages.

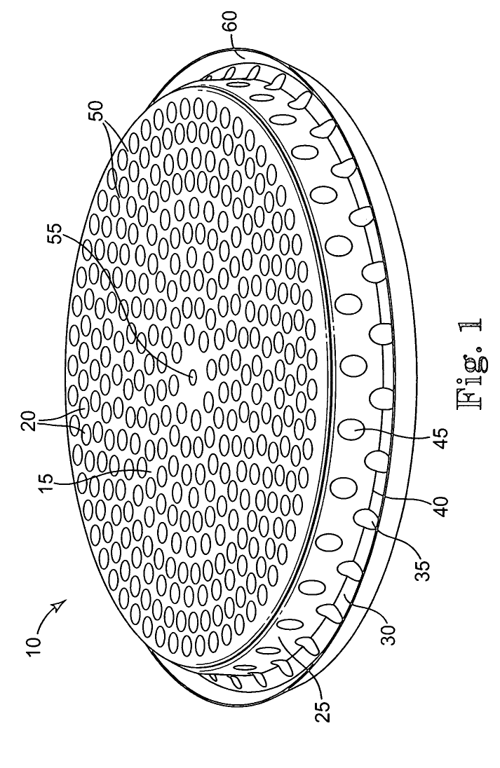

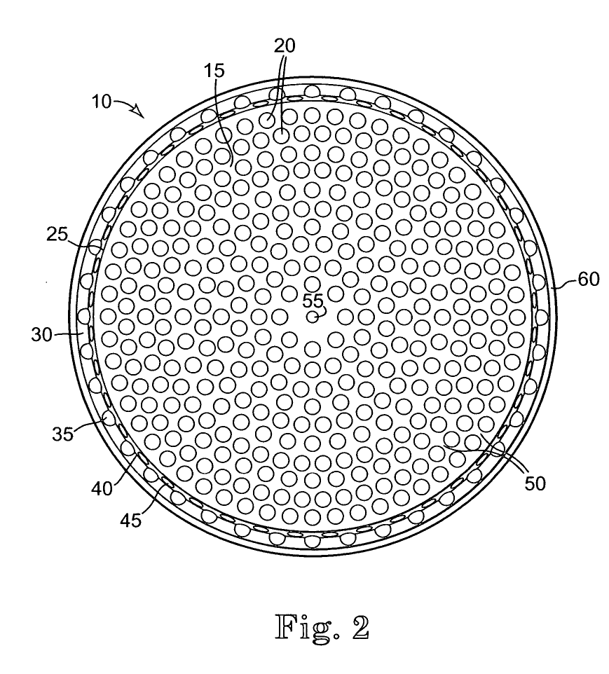

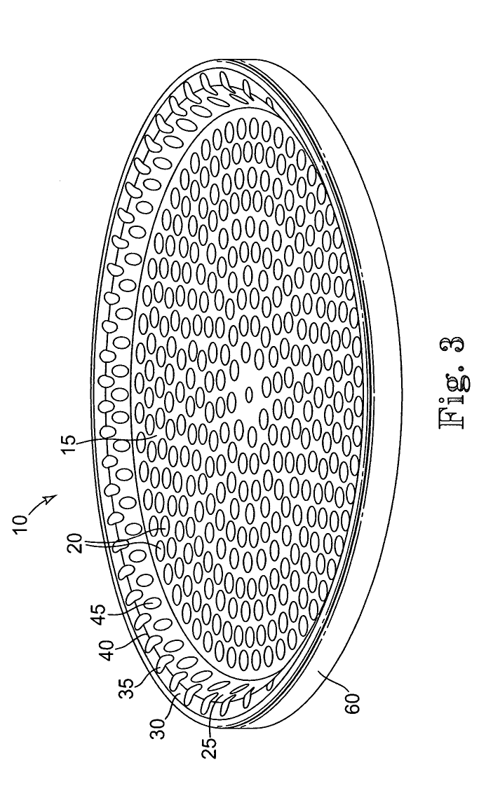

To achieve these and/or other advantages, shield 10 for a food product in a baking environment is shown in e.g. FIGS. 1-4. Shield 10 is constructed for manual placement into close association with a pan for supporting the food product, as will be described. Shield 10 comprises first region 15 defining a plurality of first apertures 20 extending through shield 10. Shield 10 also comprises sidewall 25 bordering first region 15, and ledge 30 bordering sidewall 25. Ledge 30 at least partially defines a plurality of second apertures 35 extending through shield 10. The plurality of second apertures 35 extends across border 40 between ledge 30 and sidewall 25 such that a portion of each second aperture 35 is defined in ledge 30 and another portion of each second aperture 35 is defined in sidewall 25. As will be described, ledge 30 is constructed for support by a rim of the pan, and the plurality of second apertures 35 is constructed to allow airflow away from the food product outwardly through shield 10.

According to the illustrated embodiment, second apertures 35 are defined partially within sidewall 25 and partially within ledge 30. More than half of each second aperture 35 is defined within ledge 30, and less than half of each second aperture 35 is defined within sidewall 25, as shown in FIG. 1. The ratio of second-aperture portion in ledge 30 to second-aperture portion in sidewall 25 is about 55-45, about 60-40, about 65-35, about 70-30, about 75-25, about 80-20, and/or about 85-15, according to embodiments of the invention.

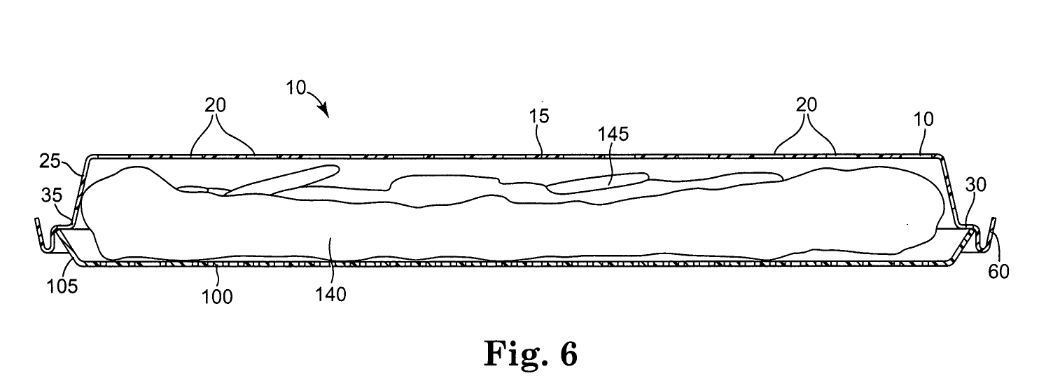

Sidewall 25 defines a plurality of third apertures 45 extending through shield 10. The plurality of third apertures 45 is defined entirely within sidewall 25, according to the illustrated embodiment. Each second aperture 35 and third aperture 45 of shield 10 is constructed to allow airflow through shield 10 and away from the food product underneath shield 10. Second apertures 35, extending across border 40 between ledge 30 and sidewall 25, along with third apertures 45, provide advantages in that e.g. they allow enhanced outward airflow in the region of an outer crust of the food product, for example a pizza crust. Ledge 30 also is of dimension sufficient to permit such airflow when shield 10 is supported on the rim of a pizza pan or other utensil, as will be described e.g. with reference to FIG. 6.

According to embodiments of the invention, first region 15 is a top region or top surface of shield 10. Apertures 20 and/or apertures 35, 45 are in the form of perforations, for transmission of convective heat, impingement airflow, or the like. Sidewall 25 extends downwardly from top surface 15 at a desired angle, and this construction and other features of shield 10 allow compact, generally nested stacking of multiple shields 10 if desired, e.g. in a commercial restaurant environment. Shields 10 may be stacked upside down, for example, for cooling between uses.

According to the embodiment illustrated in FIGS. 1-4, ledge 30 is disposed generally parallel to first region 15 and, if shield 10 is placed on a generally flat surface, is generally parallel to that surface. According to alternative embodiments, ledge 30 is disposed at angle relative to first region 15 and any generally flat surface on which shield 10 rests. In either case, again according to certain embodiments of the invention, second apertures 35 of ledge 30 and third apertures 45 of sidewall 25 generally alternate with each other circumferentially around shield 10. Additionally, first apertures 20 of first region 15 are arranged in generally concentric rings 50 about center 55 of shield 10. Center 55 is defined by a center aperture, as shown in FIG. 1. Each first aperture 20 is constructed to allow airflow toward a food product underneath shield 10 in a baking environment, e.g. an impingement oven with generally downwardly directed impinging air jets, for eventual outflow through second apertures 35 and third apertures 45.

Shield 10 also includes lip 60, bordering ledge 30 around the outside circumference thereof and forming an outer circumference of shield 10. Lip 60 intersects ledge 30 and extends at an angle to ledge 30. Further, lip 60, which optionally is in the form of a rolled edge of shield 10, is of suitable dimension and shape for gripping by a gripper or other tool used to manually place shield 10 in and remove shield 10 from a desired location, e.g. on top of a pan. The same gripper used for manual placement of shield 10 also may be used for manual placement of the pan.

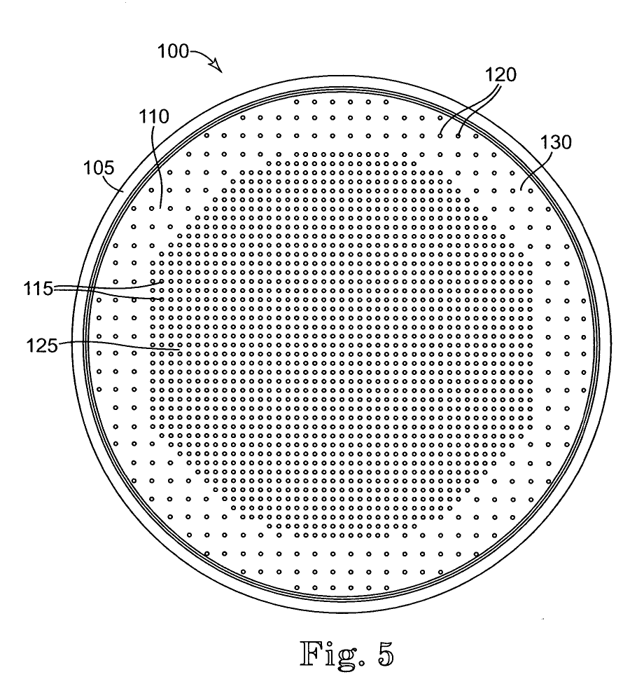

FIG. 5 shows one type of pan 100 used with shield 10, according to an embodiment of the invention. Pan 100 includes outer rim 105 disposed at an obtuse angle with respect to base 110 of pan 100. A wide variety of obtuse angles are possible, to produce desirable results with respect to a particular food product or baking situation, as will be apparent to those of ordinary skill. Base 110 of pan 100 includes a plurality of perforations 115, 120, disposed in two distinct regions 125, 130. Perforations 120 within outer region 130 are spaced farther apart than are perforations 115 of central region 125, as shown. Various other features and advantages of pan 100 are described in and/or will be apparent from commonly assigned U.S. Pat. No. 5,680,956, which is incorporated by reference herein. Of course, other pan embodiments are contemplated for use with shield 10.

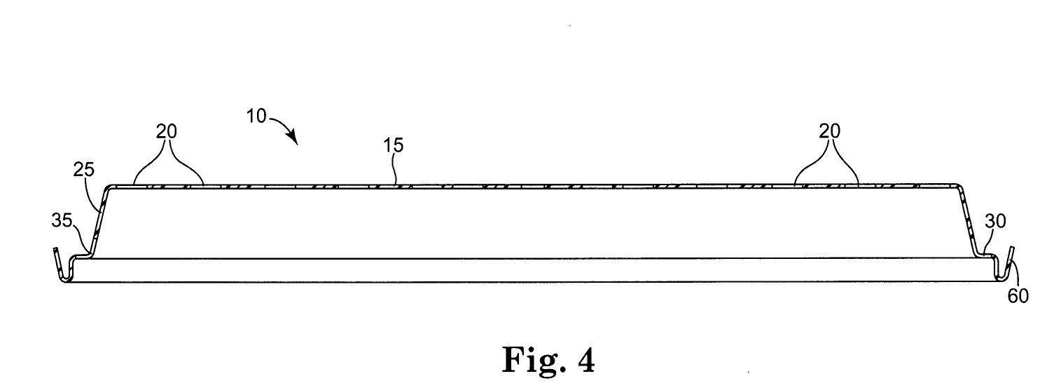

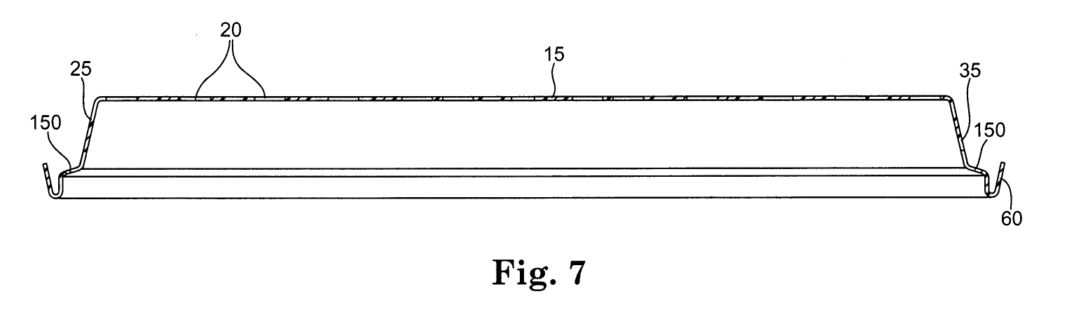

FIG. 6 depicts shield 10 in use on top of pan 100, with pan 100 supporting pizza or other food product 140 having toppings 145. Rim 105 of pan 100 is constructed to contact and support ledge 30 of shield 10 generally at the intersection of ledge 30 and lip 60. Ledge 30 and the inner portion of lip 60 help guide shield 10 to a desired, generally centered position with respect to underlying pan 100. Food product 140 generally is free of contact with shield 10, according to certain embodiments, although according to other embodiments such contact is acceptable. FIG. 7 illustrates alternative ledge 150, which is angled with respect to lip 60 to a greater extent than is ledge 30 of e.g. FIG. 4, and is angled with respect to e.g. first region 15 of shield 10 instead of parallel to it. First region 15 optionally defines a plane that is generally parallel to the plane of a surface on which shield 10 rests, and alternative ledge 150 is angled with respect to that plane.

According to embodiments of the invention, a pizza or other food product is prepared and placed in a pizza pan such as pan 100. Shield 10 is placed on top of pan 100, and pan 100, shield 10 and the food product together are directed to pass through a baking environment, e.g. a conveyor oven. After passing through the oven, shield 10 is removed from pan 100 with pan grippers or similar tool, and the pizza and pan are removed to a cut table or other location for cutting or further processing before serving or delivery.

A specific method of shielding a food product in a baking environment thus comprises placing shield 10 and food product 140 in close association with each other, shield 10 having a shape generally corresponding to the shape of food product 140, shield 10 comprising first region 15 defining a plurality of first apertures 20 extending through shield 10, sidewall 25 bordering first region 15, and ledge 30 bordering sidewall 25 and at least partially defining a plurality of second apertures 35 extending through shield 10. The method further comprises directing heated air through the plurality of first apertures 20 toward food product 140 and then through the plurality of second apertures 35 away from food product 140. The method further comprises placing food product 140 in pan 100 having rim 105, and supporting ledge 30 of shield 10 on rim 105 of pan 100. Food product 140 optionally is pizza. Sidewall 25 defines a plurality of third apertures 45 extending through shield 10; and the method includes directing heated air through the plurality of third apertures 45 away from food product 140. The baking environment optionally comprises an oven, for example a conveyor oven, and the method comprises disposing pan 100, food product 140 and shield 10 in the oven for about 8.5 minutes at about 430° F., regardless of oven load or number of toppings 145 on food product 140.

Shield 10 is produced of aluminum or other conductive metal, preferably stiff enough to prevent undesirable deformation when shield 10 is lifted from an oven or other location, e.g. manually by a pan gripper or other tool. A wide variety of materials are contemplated according to the invention, including stainless steel, copper alloys and other materials. The material preferably is of a thickness to create a relatively stiff and strong shield that can withstand the stresses typically associated with placement over pans and insertion and removal from ovens, but other thicknesses also are contemplated as needed. Additionally, shield 10 is of one-piece construction, according to certain embodiments of the invention, and the borders between areas of shield 10, e.g. border 40 between sidewall 25 and ledge 30, for example, are defined by bends in the one piece of material from which shield 10 is formed.

According to one embodiment, shield 10 has a diameter of about 16.5 inches, yielding a shield surface area of about 213.8 square inches. Apertures 20, 35, 45 are each of about 0.5 inch diameter, such that each aperture defines an area of about 0.196 square inches. According to one embodiment, shield 10 includes about 448 apertures, for a total aperture area of about 87.9 square inches. Thus, shield 10 includes an “open” area of about 41%. Shield 10 also is about 1.6 inches in a top-to-bottom or vertical dimension. Of course, a wide variety of dimensions are contemplated for the disclosed embodiments and features.

Shield embodiments and corresponding method embodiments according to the invention provide a number of advantages, including generally preventing food product such as pizza from excessive darkening, toughness or other undesired texture or appearance. Soft texture, correct color of the food product and any toppings, and other characteristics are maintained generally regardless of oven type, oven load, location within the oven, or number/amount of pizza toppings, for example. Shield 10 extends preferably, though not necessarily, all the way across the top of food product 140 resting in pan 100. Many baking environments, in e.g. chain pizza restaurants, subject the baked products to extreme temperatures, as mentioned above, with the goal of significantly reducing the baking time. Many pizza toppings, however, can become significantly overbaked because of their direct exposure to the harsh oven environment. Shield 10 provides a gentler bake, because it significantly limits the amount of heated air flowing to the product, without eliminating it entirely. Shield 10 acts as a diffuser and creates an environment between it and the underlying food product in the form of a reduced-speed, and/or altered-turbulence, air barrier having limited/altered convection characteristics and/or different heat-transfer characteristics. Evaporation and consequent cooling also are reduced. Other advantages will be apparent to those of ordinary skill.

Although the invention has been described with respect to certain specific embodiments, those of ordinary skill in the art will appreciate that the invention contemplates a large number of variations and modifications beyond those specifically disclosed herein. For example, shield 10 is illustrated in a generally circular shape, e.g. to generally correspond to a pizza pan or other utensil carrying a food product to be shielded, or to a circular pizza itself. A generally square shape, polygonal shape, or other shape is also considered advantageous, especially (although not exclusively) if the underlying utensil or if the food product itself is a generally similar shape. Embodiments of the invention also extend to pizzas and other food products produced according to the apparatus and methods described herein. Although the terms “bake” and the like have been used herein to simplify the disclosure, these terms should be interpreted to apply equally well to other types of heating and/or cooking, not just “baking” in a strict sense. Other variations and modifications within the scope of the invention also will be apparent to those of ordinary skill.

What is claimed is:

1. A shield for a food product in a baking environment, the shield being constructed for manual placement into close association with a pan for supporting the food product, the shield having a shape generally corresponding to the pan, the shield comprising a first region defining a plurality of first apertures extending through the shield, a sidewall bordering the first region, and a ledge bordering the sidewall and at least partially defining a plurality of second apertures extending through the shield, wherein the plurality of second apertures extends across the border between the ledge and the sidewall such that a portion of each second aperture is defined in the ledge and another portion of each second aperture is defined in the sidewall.

2. The shield of claim 1, wherein the sidewall defines a plurality of third apertures extending through the shield.

3. The shield of claim 2, wherein the plurality of third apertures is defined entirely within the sidewall.

4. The shield of claim 1 in combination with a pan, the pan comprising a rim, wherein the rim of the pan is constructed to contact and support the ledge of the shield.

5. The shield of claim 1, further comprising a lip intersecting the ledge and extending at an angle to the ledge.

6. The shield of claim 5 in combination with a pan, the pan comprising a rim, wherein the rim of the pan is constructed to contact the ledge of the shield generally at the intersection between the ledge and the lip.

7. The shield of claim 5, wherein the lip is constructed for contact with a pan gripper for manual placement of the shield.

8. The shield of claim 1, wherein each second aperture is constructed to allow airflow away from the food product in the baking environment.

9. The shield of claim 1, wherein the ledge is disposed generally parallel to the first region.

10. The shield of claim 1, wherein the ledge is disposed generally at an angle to the first region.

11. The shield of claim 1, wherein the shield is of one-piece construction.

12. The shield of claim 1, wherein the first apertures are arranged in generally concentric rings about a center of the shield.

13. The shield of claim 12, wherein the sidewall defines a plurality of third apertures extending through the shield; further wherein the second apertures of the ledge and the third apertures of the sidewall alternate with each other circumferentially around the shield.

14. A pizza shielded by the shield of claim 1.

15. A method of shielding a food product in a baking environment, the method comprising:
placing a shield and a food product in close association with each other, the shield having a shape generally corresponding to the shape of the food product, the shield comprising a first region defining a plurality of first apertures extending through the shield, a sidewall bordering the first region, and a ledge bordering the sidewall and at least partially defining a plurality of second apertures extending through the shield; and
directing heated air through the plurality of first apertures toward the food product and then through the plurality of second apertures away from the food product.

16. The method of claim 15, further comprising placing the food product in a pan having a rim, and supporting the ledge of the shield on the rim of the pan.

17. The method of claim 15, wherein the food product is pizza.

18. The method of claim 15, wherein the sidewall defines a plurality of third apertures extending through the shield; further wherein the method comprises directing heated air through the plurality of third apertures away from the food product.

19. The method of claim 15, wherein the baking environment comprises an oven, further wherein the method comprises disposing the pan, food product and shield in the oven for about 8.5 minutes at about 430° F. regardless of oven load or number of toppings on the food product.

20. A pizza produced by the method of claim 15.

21. A shield for a food product in a baking environment, the shield being constructed for manual placement into close association with a pan for supporting the food product, the shield having a shape generally corresponding to the pan, the shield comprising a first region defining a plurality of first apertures extending through the shield, a sidewall bordering the first region, and a ledge bordering the sidewall and at least partially defining a plurality of second apertures extending through the shield, the ledge being constructed for support by a rim of the pan, wherein the plurality of second apertures are constructed to allow airflow away from the food product outwardly through the shield.
